(19) United States
(12) Patent Application Publication
(10) Pub. No.: US 2019/0316366 A1
(43) Pub. Date: Oct. 17, 2019

(54) DRYWALL CORNER BEAD CLINCHER

(71) Applicant: TTI (MACAO COMMERCIAL OFFSHORE) LIMITED, Macau (MO)

(72) Inventors: Clinton C. Thackery, Clemson, SC (US); Jacob F. Creasman, Anderson, SC (US)

(21) Appl. No.: 16/377,341

(22) Filed: Apr. 8, 2019

Related U.S. Application Data
(60) Provisional application No. 62/657,258, filed on Apr. 13, 2018.

(51) Int. Cl. E04F 21/00; B25B 27/14

(52) U.S. Cl. CPC E04F 21/0061; B25B 27/146

(57) ABSTRACT

A clincher tool including a body including a first face and a second face substantially perpendicular to the first face. The clincher tool further includes an anvil slidably coupled to the body, the anvil being coupled to a first finger and a second finger, the anvil being movable between a first position and a second position. The first finger being movable inwardly in a direction from the first face towards the second face and the second finger being movable inwardly in a direction from the second face towards the first face, providing a force to clinch a corner bead to a corner. An impacting member is coupled to the body and configured to impact the anvil for moving the first finger and the second finger to clinch the corner bead.

### CROSS-REFERENCE TO RELATED APPLICATIONS

This application claims priority to co-pending U.S. Provisional Patent Application No. 62/657,258 filed on Apr. 13, 2018, the entire content of which is incorporated herein by reference.

### FIELD

The present subject matter relates to a tool for attaching a corner bead to drywall.

### BACKGROUND

Corner beads are applied to drywall during interior construction of a space (e.g., an office, a home, and/or the like) for providing and defining angle corners. Structurally rigid corner beads protect fragile exposed portions of a drywall sheet as two drywall sheets abut each other to form a corner. Corner beads are applied using a drywall corner bead clincher tool, which crimps the rigid corner bead into the softer drywall sheets, when struck by a mallet. Existing clincher tools are difficult to handle and maneuver. For example, a user must grasp the clincher tool by a plate that is bent at a 90 degree angle, and then hold the plate using one hand while impacting the clincher tool with a mallet using the other hand. Such two-handed operation of existing clincher tools is cumbersome, inefficient, and injury prone.

### SUMMARY

In one embodiment, the subject matter provides a clincher tool including a body, including a first face and a second face substantially perpendicular to the first face. The clincher tool further includes an anvil slidably coupled to the body, the anvil being coupled to a first finger and a second finger, as the anvil being movable between a first position in which the anvil is at a distal location with respect to the body and a second position in which the anvil is at a proximal location with respect to the body, the first finger being movable inwardly in a direction from the first face towards the second face and the second finger being movable inwardly in a direction from the second face towards the first face, providing a force configured to clinch a corner bead to a corner. The clincher tool including an impacting member coupled to the body, the impacting member configured to impact the anvil for moving e first inner and the second finger to clinch the corner bead.

Other features and aspects of the subject matter will become apparent by consideration of the following detailed description and accompanying drawings.

### BRIEF DESCRIPTION OF THE DRAWINGS

FIG. 1 is a perspective view of a clincher tool according to one embodiment.

FIG. 2 is a top perspective view of a portion of the clincher tool of FIG. 1.

FIG. 3 is a perspective view of a portion of the clincher tool of FIG. 1.

FIG. 4 is a perspective view of a clincher tool according to another embodiment of the present subject matter.

FIG. 5 is a perspective view of a clincher tool according to another embodiment of the present subject matter.

FIG. 6 is a perspective view of a clincher tool according to another embodiment of the present subject matter.

FIG. 7 is a perspective view of a clincher tool according to another embodiment of the present subject matter.

Before any embodiments of the present subject matter are explained in detail, it is to be understood that the subject matter is not limited in its application to the details of construction and the arrangement of components set forth in the following description or illustrated in the following drawings. The present subject matter is capable of other embodiments and of being practiced or of being carried out in various ways. Also, it is to be understood that the phraseology and terminology used herein is for the purpose of description and should not be regarded as limiting.

### DETAILED DESCRIPTION

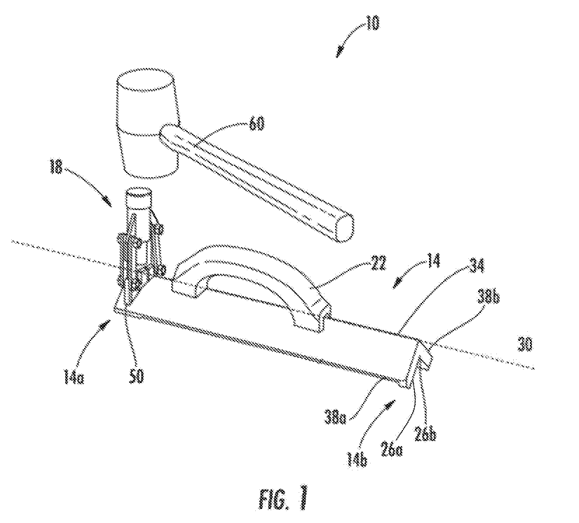

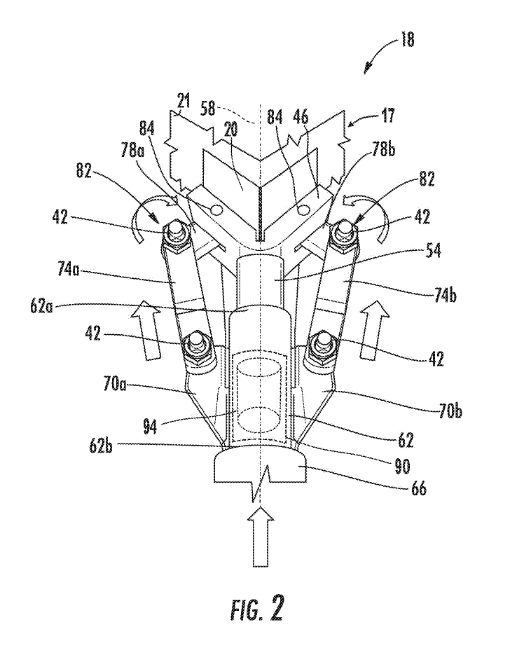

FIGS. 1-3 illustrate a clincher tool 10 according to one embodiment. The clincher tool 10 includes a body or positioning member 14, which engages a drywall corner 17 (FIG. 2), and a clincher mechanism or clincher 18 for securing a corner bead 20 (FIG. 2) to the drywall 21 (FIG. 2). The positioning member 14 includes a handle 22 that is grasped by the user to hold the tool 10 while attaching the corner bead 20. The handle 22 may include a D-shaped handle that is secured to the plate, or any other size and/or shape of handle that is non-D-shaped. The tool 10 may include multiple handles, in some embodiments.

As shown in FIG. 1, the illustrated positioning member 14 is generally angled, and includes a first body portion 38a having a first face 26a and second body portion 38b having a second face 26b. The positioning member 14 may be bent along a longitudinal axis 30, for forming an edge 34 between the first body portion 38a and the second body portion 38b. The edge 34 may be bent such that the first and second body portions 38a, 38b are substantially normal to each other about the axis 30 for forming a 90-degree corner. The first face 26a and the second face 26b contact the corner bead 20. With reference to FIG. 1, the handle 22 is coupled to the positioning member 14 along the edge 34. The handle 22 may be attached to the positioning member 14 via a fastener (e.g., nut, bolt, clip, tongue-in-groove configuration, and/or the like) or via alternative attachment members and/or methods. One such alternative method may include moving (e.g., sliding) the handle 22 in and/or along a groove of the positioning member 14, and fastening the handle 22 to the positioning member 14 at a desired location within the groove. The handle 22 may be substantially offset from and parallel to the longitudinal axis 130. The handle may be offset from the longitudinal axis at a distance that more easily allows a user to grasp the handle 22 using a hand. In this way, the gripping, handling, and maneuverability of the tool 10 to form a corner bead improves.

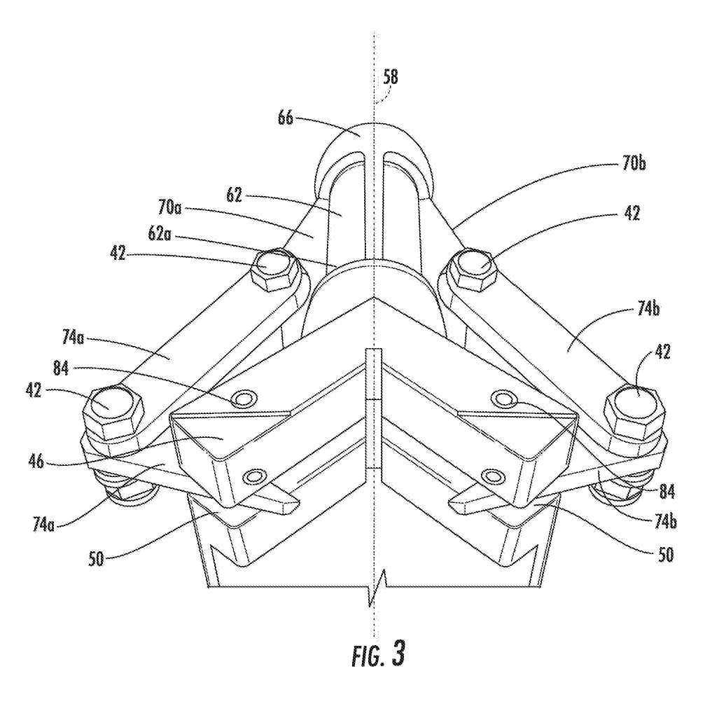

The positioning member 14 may include a first end 14a adjacent the clincher 18 and a second end 14b substantially opposite the first end 14a. The clincher 18 may include a plate 46 which is integrated with the positioning member 14. In some embodiments, the plate 46 is bent along the longitudinal axis 30 in generally the same manner as the positioning member 14 (e.g., to assume a same or similar size and/or shape as the positioning member 14). The plate 46 may include one or more grooves or slots 50 (FIG. 3) positioned adjacent the clincher 18 and between the first end 14a and the second end 14b of the clincher tool 10. The grooves or slots 50 extend through the plate 46. One groove or slot 50 is formed within the first body portion 38a, and another groove or slot 50 is formed within the second body portion 38b. Such slots 50 are configured to guide and/or retain movable portions of the clincher 18 during formation of a corner bead.

With reference to FIG. 2, a tube 54 may be coupled to the plate 46 and extend along a striking axis 58, which may be perpendicular to the longitudinal axis 30. An anvil 62 is slidably connected to the tube 54 via a cavity extending through the anvil 62. The tube 54 is positioned within the cavity 90 at a first end of the anvil 62a. A biasing member 94 (e.g., a spring, and/or the like) is positioned within the cavity 90 at a second end of the anvil 62b. The anvil 62 may move relative to the positioning member 14 towards the tube 54 along the striking axis 58. As the anvil 62 moves towards the tube 54 (e.g., towards the positioning member 14), the biasing member 94 may transition from being biased in a relaxed or semi-relaxed state to being biased in a biased state. As the anvil 62 moves away from the tube 54 (and away from the positioning member 14), the biasing member 94 relaxes from the biased state and transitions to the relaxed or semi-relaxed state. A cap 66 may be coupled to the second end of the anvil 62b and provide an impact zone for being struck by a hammer 60 (V1) or other type of impacting tool.

As the anvil 62 moves towards the positioning member 14, the anvil 62 transmits the direction of the impacting force from the striking axis 58, which extends through the anvil 62, to directions which extend generally perpendicular to each the first face 26a and the second face 26b of the positioning member 14 of the clincher tool 10 and extend towards the corner 17. In this way, such impacting force(s) may form the corner bead 20 into the drywall corner 17 by way of the force(s) being transferred to the corner bead 20 through the anvil 62.

The anvil 62 further includes a first flange 70a and a second flange 70b. The flanges 70a, 70b couple to a first linkage 74a and a second linkage 74b, respectively, via fasteners 42. The linkages 74a, 74b additionally couple to a first finger 78a and a second finger 78b, respectively, via fasteners 42. The connection between the fingers 78a, 78b and linkages 74a 74b, creates a pivot point 82 for the clincher 18. A first pivot point 82 is formed and/or disposed between the first finger 78a and the first linkage 74a. A second pivot point 82 is formed and/or disposed between the second finger 78b and the second linkage 78b. The pivot points 82 permit the rotation of the fingers 78a, 78b with respect to the anvil 61 The fingers 78a, 78b are slidably positioned within the slots 50 such that the fingers 78a, 78b move relative to the plate 46. The fingers 78a, 78b also engage pins 84 which traverse the slots 50 in directions parallel to and spaced from the longitudinal axis 30 of the positioning member 14. Thus, the fingers 78a, 78b are coupled to the positioning member 14 for rotation through the slots 50. The fingers 78a, 78b extend through the slots 50, and are coupled for rotation about the positioning member 14 through the pins 84.

During operation, the user may align the first face 26a and the second face 26b of the clincher tool 10 against the drywall corner 17 by grasping the handle 22 with one hand. As such, the striking axis 58 of the anvil 62 is aligned with the drywall corner 17. A striking force is imparted against the cap 66 of the anvil 62 via the hammer 60. As the hammer 60 contacts the cap 66, the anvil 62 moves toward the positioning member 14 along the striking axis 58, causing the tube 54 to bias the biasing member 94 from the relaxed or semi-relaxed state to the biased state. Simultaneously, the first and second linkages 74a, 74b move towards the plate 46, causing the fingers 78a, 78b to pivot about the pivot point 82, retract into the slots 50 and impart a force into the drywall corner 17. The force secures the corner bead 20 to the drywall 21, at which point the tool 10 may be removed from the drywall corner 17.

FIGS. 4-7 illustrate additional respective clincher tools 100, 200, 300, and 400 according to other respective embodiments of the present subject matter.

In an alternative embodiment shown in FIG. 4, the clincher tool 100 may be actuated using an impacting member, such as a fastener driver 102 that is attached to and/or integrated with a positioning member 114 of the tool 100. The fastener driver 102 may be coupled to the positioning member 114 via fasteners, a welded attachment, and/or the like. More specifically, the fastener driver 102 may be coupled along the edge 134 of the positioning member 114, and along the longitudinal axis 130. A handle 122 of the fastener driver 102 may be offset from and parallel to the longitudinal axis 130. The handle 112 may include a lever 106 acting as a trigger, and a grip 110. As such, the user is able to hold and actuate the tool 100 with the same hand. In this way, the use and/or handling of the tool may become less cumbersome, and be improved. The handle 122 may include a protrusion, such as an arm 123, that connects the handle to the positioning member 114 between a first end 114a of the positioning member 114 and a second end 114b of the positioning member 114, and more specifically, between the fastener driver 102 and the second end 114b of the positioning member 114. An impacting mechanism of the fastener driver 102 is coupled to the clincher tool 100 such that when a user depresses the lever 106 a spring-loaded hammer provides an impacting force to drive the clincher towards the drywall corner 17 and secure the corner bead 20 to the drywall 21. Specifically, the spring-loaded hammer may impact an anvil similar to the anvil 62 as shown in FIG. 2. The spring-loaded hammer may be a part of the fastener driver 102. The anvil 62 may cause fingers 78a and 78b to rotate inwardly and apply the impacting force to the corner bead 20.

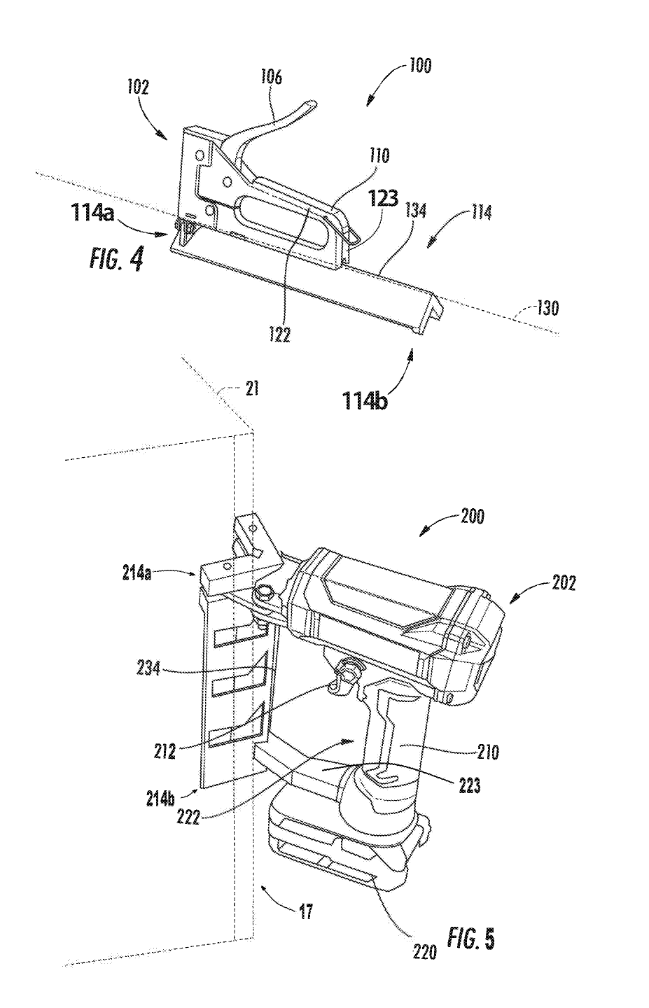

In an alternative embodiment shown in FIG. 5, the clincher tool 200 may be actuated using an electric (e.g., a battery-powered) impacting member, such as an electric fastener driver 202. More specifically, the fastener driver 202 may couple to the edge 234 of the positioning member 214 along the longitudinal axis 230. A handle 222 of the fastener driver 202, which may be substantially offset from and parallel to the longitudinal axis 230, includes a grip 210 and a trigger 212. As such, the user is able to hold and actuate the tool 200 with the same hand. The handle 222 also includes an arm 223 connecting the handle to the positioning member 214 between a first end 214a of the positioning member 214 and a second end 214b of the positioning member 214, and more specifically, between the fastener driver 202 and the second end 214b of the positioning member 214. An impacting mechanism of the fastener driver 202 is coupled to the clincher such that when a user depresses the trigger 212, a motor powered by a rechargeable battery 220 provides an impacting force to drive the clincher towards the drywall corner 17 and secure the corner bead 20 to the drywall 21. Specifically, a member driven by the motor may impact an anvil similar to the anvil 62 as shown in FIG. 2. The member driven by the motor may be a part of the fastener driver 202. The anvil 62 may cause fingers 78a, 78b to rotate inwardly and apply the impacting force to the corner bead 20.

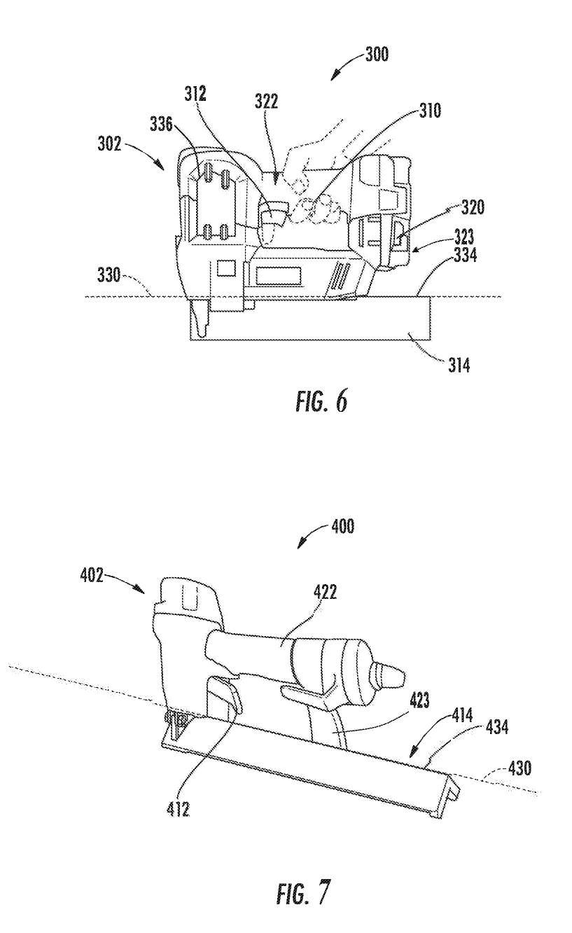

In an alternate embodiment shown in FIG. 6, the clincher tool 300 may be actuated using a battery-powered impacting member, such as a battery powered fastener driver 302 with an on-board fluid chamber 336 which may be compressed by a motor powered by a rechargeable battery 320. The compressed fluid chamber 336 may be opened or released to drive the clincher towards the drywall corner 17 and secure the corner bead 20 to the drywall 21. Thus, the compressed fluid of the compressed fluid chamber 336 provides the impacting force, and the impacting force is transmitted from the compressed fluid to the clincher 318, and ultimately, to the corner bead 20. Specifically, a member driven by the release of compressed fluid may impact an anvil similar to the anvil 62 as shown in FIG. 2. The member driven by the release of compressed fluid may be a part of the fastener driver 302. The anvil 62 may cause fingers 78a, 78b to rotate inwardly and apply the impacting force to the corner bead 20. Similar to the alternate embodiment shown in FIG. 5, the fastener driver 302 couples to the edge 334 of the positioning member 314 along the longitudinal axis 330. A handle 322 of the fastener driver 302 is substantially offset from and parallel to the longitudinal axis 330, and includes a grip 310 and a trigger 312. The handle 322 also includes an arm 323 connecting the handle 322 to the positioning member 314 between a first end 3114a of the positioning member 314 and a second end 314b of the positioning member 314, and more specifically, between the fastener driver 302 and the second end 314b of the positioning member 314. As such, the user is able to hold and actuate the tool 300 using the same hand.

In an alternative embodiment shown in FIG. 7, the clincher tool 400 may be actuated using a pneumatic-powered impacting member, such as a pneumatic-powered fastener driver 402. More specifically, the pneumatic fastener driver may couple to the edge 434 of the positioning member 414 along the longitudinal axis 430. A handle 422 of the fastener driver 402, which is substantially offset from and parallel to the longitudinal axis 430, includes a grip 410 and a trigger 412. The handle 422 also includes a protrusion 423 connecting the handle 422 to the positioning member 414 between a first end 414a of the positioning member 414 and a second end 414b of the positioning member 414, and more specifically, between the pneumatic-powered fastener driver 402 and the second end 414b of the positioning member 414. As such, the user is able to hold and actuate the tool 400 with the same hand. An impacting mechanism of the fastener driver 402 is coupled to the clincher such that when a user depresses the trigger 412, an air compressor (not shown) provides an impacting force to drive the clincher towards the drywall corner 17 and secure the corner bead 20 to the drywall 21. Specifically, a member driven by the pneumatic powered fastener driver 402 may impact an anvil similar to the anvil 62 as shown in FIG. 2. The member driven by the pneumatic powered fastener driver 402 may be a part of the fastener driver 402. The anvil 62 may cause fingers 78a, 78b to rotate inwardly and apply the impacting force to the corner bead 20.

The embodiment(s) described above and illustrated in the figures are presented by way of example only and are not intended as a limitation upon the concepts and principles of the present disclosure. As such, variations and modifications to the elements and their configuration and/or arrangement exist within the scope of one or more independent aspects as described.

Various features of the present subject matter e set forth in the following claims.

What is claimed is:

1. A clincher tool, comprising:
a body including a first face and a second face substantially perpendicular to the first face;
an anvil slidably coupled to the body,
the anvil being coupled to a first finger and a second finger,
the anvil being movable between a first position, in which the anvil is at a distal location with respect to the body, and a second position, in which the anvil is at a proximal location with respect to the body,
the first finger being movable inwardly in a direction from the first face towards the second face and the second finger being movable inwardly in a direction from the second face towards the first face, providing a force configured to clinch a corner bead to a corner; and
an impacting member coupled to the body,
the impacting member being configured to impact the anvil for moving the first finger and the second finger to clinch the corner bead.

2. The clincher tool of claim I, wherein:
a handle is disposed on the impacting member,
the handle is configured to be grasped by a user, and
the handle is spaced apart from the body to define an opening between the handle and the body.

3. The clincher tool of claim 1, wherein:
the clincher tool has a first end and a second end, and
the anvil is adjacent the first end of the clincher tool.

4. The clincher tool of claim 2, wherein the handle is coupled o the body between the anvil and the second end of the clincher tool.

5. The clincher tool of claim 2, wherein the handle is coupled to the body by a fastener.

6. The clincher tool of claim 1, wherein the body includes a first slot extending through the first face and a second slot extending through the second face.

7. The clincher tool of claim 6, wherein the first finger is coupled to the body for rotation through the first slot, and the second finger is coupled to the body for rotation through the second slot.

8. The clincher tool of claim 1, wherein the anvil moves from the first position to the second position by an impacting force generated by the impacting member.

9. The clincher tool of claim 1, herein the impacting member is an electrically actuated driver.

10. The clincher tool of claim 1, wherein:
the impacting member includes a trigger, a handle, and an impacting tool, and
the trigger and the handle are arranged spatially such that a user can grasp the handle and actuate the impacting mechanism with one hand via the trigger.

11. The clincher tool of claim 1, wherein the impacting member includes a spring-powered driver.

12. The clincher tool of claim 1, wherein the impacting member includes a battery-powered driver.

13. The clincher tool of claim 1, wherein the impacting member includes a pneumatic-powered driver.

14. The clincher tool of claim 1, wherein the first face and the second face of the body are operable to align a striking axis of the anvil with the corner.

15. The clincher tool of claim 1, wherein as the anvil is moved from the first position to the second position, the fingers exert a clamping force on a corner bead.

16. The clincher tool of claim 1, wherein the anvil, the first finger, and the second finger transmit an impacting force imparted by the impacting member from the anvil to a work surface.

17. The clincher tool of claim 16, wherein the first finger includes a first pivot point permitting rotation of the first finger with respect to the anvil, and the second finger includes a second pivot point permitting rotation of the second finger with respect to the anvil.

18. The clincher tool of claim 1, wherein the anvil transmits the direction of the impacting force from a striking axis extending through the anvil to directions which extend generally perpendicular to each the first face and the second face of the body of the clincher tool and extend towards the corner.
